(19) United States
(12) Patent Application Publication
(10) Pub. No.: US 2021/0315060 A1
(43) Pub. Date: Oct. 7, 2021

(54) HEATING TEXTILE, METHOD OF PRODUCTION AND USE THEREOF

(71) Applicants: Thorsten JAHN, Schwarzenbach/Wald (DE); Mario BROWA, Geroldsgruen (DE)

(72) Inventor: Mario BROWA, Geroldsgruen (DE)

(21) Appl. No.: 17/056,386

(22) PCT Filed: May 15, 2019
(86) PCT No.: PCT/EP2019/062488

§ 371 Date: Nov. 17, 2020

(30) Foreign Application Priority Data
May 17, 2018 (DE) 10 2018 111 861.9
May 17, 2018 (DE) 10 2018 111 893.7

(51) Int. Cl. H05B 3/34; H05B 3/14

(52) U.S. Cl. CPC H05B 3/347; H05B 3/145; H05B 2203/029; H05B 2203/017; H05B 2203/015

(57) ABSTRACT

A heating textile for transmission of heat to an environment, including electrically conductive fibre threads configured for conducting electrical energy, energy-delivering fibre strands configured for heating the environment, contacts for forming at least one closed circuit, and at least one coupling fibre strand configured for contacting coupling of the energy-delivering fibre strands with the electrically conductive fibre strands and/or of the contacts with the electrically conductive fibre strands, wherein the electrically conductive fibre strands and/or the contacting fibre strands and/or the energy-delivering fibre strands are formed as pillar fibre strands and/or weft fibre strands, and the at least one coupling fibre strand is warp knitted and/or laid and/or weft knitted directly or indirectly around the pillar fibre strands and weft fibre strands in stitch-like manner.

The present invention relates to a heating textile for transmission of heat to an environment in accordance with the introductory part of claim 1.

Heating textiles known from the prior art comprise, apart from heating conductors, invariably also contact conductors which make possible the flow of electric current in order to heat the heating conductor. Thus, for example, DE 101 12 405 A1 discloses an area heating element with a textile base material. The contact conductors are glued beforehand to a textile base material produced to finished state. The heating conductors are separately added only in a further method step completely decoupled therefrom. Consequently, the result is an area heating element which is time-consuming and costly to produce. Additionally disadvantageous are the numerous working steps necessary during production. In addition, the points of adhesion also represent undesired break-off locations at which the contact couple can break apart and the function of the entire area heating element can be significantly reduced.

Apart from that, the contact conductors are mostly ironed or glued onto a non-woven material so as to avoid an undesired flow of current in the sense of a short-circuit. Ironed-on contact conductors, in particular, have proved to be disadvantageous in practice, since in the course of time or in the event of corresponding bending of the heating textile at curved surfaces the ironed-on connection can break apart and contact is no longer ensured. Equally, the situation is similar with the connections which feed current and which are glued onto the finished heating textile and thus present a significant point of attack for corrosion and possible separations.

It is therefore an object of the present invention to provide a heating textile which is constructed to be low-maintenance and long-lifed. Further, it is similarly an object of the present invention to provide a uniform and reliable temperature output, to avoid overheating and to be intrinsically economic in manufacture.

This object is fulfilled in accordance with the features of claim 1.

The heating textile described herein is constructed from pillar fibre strands and weft fibre strands which form at least one fibre strand layer. In order to now construct on the one hand a stable and on the other hand a functional heating textile, pillar fibre strands and/or weft fibre strands are themselves of functional construction. By functional there is to be advantageously understood that the respective fibre strands have a specific property.

Thus, the heating textile can comprise, for example, weft fibre strands constructed to be electrically conductive. Moreover, the heating textile can comprise pillar fibre strands which heat up through feed of electrical energy and can deliver this heat to the environment. Finally, the heating textile described herein can additionally comprise contacting means which respectively form the positive pole and the negative pole. All of these mentioned fibre strands thus have a defined function so that in the common processing as a warp knitted fabric and/or as a non-crimp fabric and/or as a weft knitted fabric a functional heating textile able to selectively deliver heat to its environment is created.

The core concept of the present invention is that apart from contacting means, energy-delivering fibre strands and electrically conductive fibre strands at least one coupling fibre strand for at least contacting couple of the energy-delivering fibre strands with the electrically conductive fibre strands and/or of the contacting means with the electrically conductive fibre strands is further, thus additionally, provided, wherein the electrically conductive fibre strands and/or the contacting means and/or the energy-delivering fibre strands are constructed as pillar fibre strands and/or weft fibre strands and the at least one coupling fibre strand is warp knitted and/or weft knitted and/or laid directly or indirectly around the pillar fibre strands and weft fibre strands in stitch-like manner in order to connect these together.

All combination variants described herein of the fibre strands can be formed both directly and/or indirectly with one another. By directly there is to be understood, advantageously, direct coupling in which the fibre strands to be coupled form at least one common contact area with one another. By indirect coupling there is to be understood, advantageously, the connection in which no direct common contact area is formed between the fibre strands to be coupled. In the case of indirect coupling it is possible, for example, for an additional material to be introduced between the fibre strands to be coupled so that these form together with the material therebetween a respective common contact area. In the simplest case the coupling is formed at points of intersection of the pillar fibre strands with the weft fibre strands.

By electrically conductive elements there are to be understood, advantageously, fibre strands, non-woven material constructions, areal textiles or even film structures, wherein with particular advantage the electrically conductive elements are constructed as electrically conductive fibre strands or fibre groups. In that case, there can be understood by fibre groups a plurality of fibre strands which, in parallel with one another, can be wound or arranged in another way.

Apart from the electrically conductive elements, energy-delivering fibre strands and contacting means, the flexible heating textile described herein additionally comprises at least one coupling fibre strand, advantageously several coupling fibre strands. The coupling fibre strands serve for direct and/or indirect connection, thus coupling, of further fibre strands to be connected. For that purpose, the at least one coupling fibre strand, advantageously several coupling fibre strands, is or are directly introduced during manufacture of the heating textile. Depending on the respective embodiment, the coupling fibre strands can be warp knitted in, laid in or weft knitted. Depending on the three forms of processing described herein, the introduction or processing of the coupling fibre strands signifies fixing of the fibre strands to be connected together. Knitting of the coupling fibre strands has proved particularly advantageous, since particularly stable and strong stitches around the fibre strands to be coupled are thereby formed. In addition, the coupling fibre strands together with the fibre strands to be coupled usually form large area contact surfaces at the crossing points thereof. In the simplest case, the coupling fibre strand stitches stitch around the crossing points of the fibre strands to be connected and define only small free spaces where no common contact surfaces are present.

It has unexpectedly proved for the first time that a plurality of coupling fibre strands forms a particularly stable and reliable contacting couple between the energy-delivering fibre strands and the electrically conductive elements and/or between the contacting means and the electrically conductive elements. For that purpose, the—advantageously—several coupling fibre strands are knitted in stitch-like manner so that these directly and/or indirectly fixedly connect together the pillar fibre strands and weft fibre strands at their crossing points.

In that regard, by fixed connection there is to be advantageously understood that the—advantageously—several coupling fibre strands surround the crossing points of pillar fibre strands with weft fibre strands in stitch-like manner and thus form with the pillar fibre strands and/or weft fibre strands, which are to be connected together, a largest possible common contact area so that the contacting couple is permanently guaranteed. By largest possible common contact area between coupling fibre strands and pillar fibre strands and/or weft fibre strands there is advantageously to be understood 25% to 80% of the circumference of an individual pillar fibre strand and/or weft fibre strand.

The pillar fibre strands and/or weft fibre strands used here advantageously define an almost round or completely round cross-section. If a coupling fibre strand is now knitted around a crossing point of pillar fibre strand and weft fibre strand then the corresponding coupling fibre strand stitches around the two strands and couples these.

Since the heating textile comprises numerous pillar fibre strands and numerous weft fibre strands which are all formed at a spacing from one another and amongst one another the heating textile described herein can also be termed heating textile lattice element.

In the simplest embodiment, guidance of the coupling fibre strands around the pillar fibre strands and/or weft fibre strands takes place from below to above. It can thus be ensured that a particularly tight and firm stitch formation is made possible and thus the free space between coupling fibre strand and pillar fibre strand and/or weft fibre strand is kept as small as possible. This is of advantage particularly when the flexible heating textile after production thereof to finished state is coated in a possible method step. Due to the reduced free spaces between coupling fibre strands and pillar fibre strands and/or weft fibre strands it is now possible for the first time to coat particularly efficiently without giving rise to formation of impermeable structures. By virtue of the stitch-like arrangement of the coupling fibre strands it is thus possible for the first time to provide flexible heating textiles in the form of flexible lattice elements, which can be coated particularly efficiently and which in addition still retain the lattice element character thereof after coating, for transmission of heat to an environment.

The flexible heating textile described herein for the first time is constructed as a lattice element, for example as a non-crimp fabric, a weft knitted fabric or a warp knitted fabric, and has at least pillar fibre strands and weft fibre strands. The pillar fibre strands are also known as 0° fibre strands, which extend in longitudinal direction of the heating textile. Advantageously, the longitudinal direction of the heating textile corresponds at the same time with the transport direction during the production method. The further provided weft fibre strands are also termed 90° fibre strands and in the simplest case run transversely to the pillar fibre strands.

It is now possible for the first time for all functionalities, which the heating textile described herein has, to be provided and constructed in the form of fibre strands and/or fibre groups. By fibre strands there are to be understood, advantageously, individual fibres and/or filaments, wherein a fibre strand comprises at least one fibre and/or filament. However, with advantage a fibre strand can also be constructed as a multi-filament and/or as a multi-fibre and as an individual filament can have the characterisation tdex10 f2-3 to 96,000 tdex with 90,000 k. Natural materials, synthetic materials, inorganic materials or also organic materials or a mixture thereof are conceivable as possible fibres and/or filaments.

Further, it has unexpectedly proved advantageous to construct the electrically conductive elements as weft fibre strands. In the simplest case, the electrically conductive elements are introduced as 90° threads. Resulting therefrom in the simplest case are conductor tracks for the electrical current.

Furthermore, the energy-delivering fibre strands for heating the environment can be constructed as pillar fibre strands, also termed 0° fibre strands. These extend in the longitudinal direction of the heating textile to be produced, during the production method thereof. Advantageously, the 0° fibre strands are arranged parallel to and at a spacing from one another. The same applies to the weft fibre strands, so that through the arrangement thereof a lattice structure of the flexible heating textile is formed.

Furthermore, the contacting means for construction of at least one closed circuit can, for example, be arranged parallel to the energy-delivering fibre strands. For that purpose, the contacting means are divided into two groups. A first group forms the positive pole and a second group forms the negative pole.

In the simplest case, energy-delivering fibre strands and contacting means as mutually spaced 0° fibre strands form a plane in which the energy-delivering fibre strands and contacting means are arranged adjacent to one another.

Moreover, advantageously the contacting means are arranged to be grouped, for example in two groups. It is conceivable that at least one contacting means comprises at least one fibre and/or at least one filament. Fibres differ from filaments merely in their defined length.

Consequently, the material of the contacting means is not limited to textile fibres, glass fibres, carbon fibres or the like, but metal fibres can also be used. Moreover, non-woven materials, conductive areal textiles or, however, even electrically conductive plastics material films can also be used as contacting means.

In order to now ensure energy transmission, here—in particular—a flow of current, the flexible heating textile described herein further comprises coupling fibre strands. It has been unexpectedly discovered that by way of these coupling fibre strands for formation of a contacting couple of the further fibre strands connected therewith a particularly simple and economic production of the flexible heating textile is made possible for the first time. The heating textile lattice element can deliver efficient and constant heat to the environment without itself overheating. In that regard, it is constructed to be flexible and bendable.

In addition, a high degree of heat resistance and a high degree of thermal conductivity can be ensured, particularly in the long term.

The above-mentioned break-off locations from the prior art, which arise through glueing or soldering in known heating textiles, are not employed in the present invention. The coupling fibre stands described herein form an energetic coupling with the fibre strands connected therewith so that, for example, heat generation and also current conductance are formed appropriately through the contacting couple. For that purpose, the coupling fibre strands are warp knitted, weft knitted or laid in stitch-like manner.

In the simplest case the coupling fibre strands can, for successful contacting coupling, be constructed to be intermeshed with and/or around the electrically conductive elements, the energy-delivering fibre strands and/or the contacting means. In particular, forms of fringe stitches, tricot stitches, cloth stitches, satin stitches, atlas stitches or open body stitches or velvet stitches have proved advantageous. Particularly firm, permanently stable and secure contacting couples can be formed with all the forms of stitch listed herein, with simultaneous saving in time and cost in production and maintenance.

Moreover, it is equally conceivable for the coupling fibre strands to be directly and/or indirectly intermeshed and/or looped or twisted at the crossing points of the fibre strands, which are to be connected, in the form of fringe stitches, tricot stitches, satin stitches, atlas stitches, open body stitches, velvet stitches when the heating textile described herein is constructed as, for example, a non-crimp material. The crossing points between the pillar fibre strands and weft fibre strands can be firmly connected with one another and, in particular, in one working step during production.

By contacting coupling it is to be advantageously understood that the weft fibre strands form a contacting couple with the pillar fibre strands and conversely at the respective crossing points through the stitches surrounding them so that, for example, transmission of energy—advantageously electrical and/or in the form of heat—is made permanently possible. In addition, the intermeshing produces additional stabilisation of the bendable heating textile.

This is obviously not to be understood as limiting, so that other combinations of pillar fibre strands and weft fibre strands are also possible.

Moreover, it is also conceivable for the functional fibre strands described herein, such as energy-delivering fibre strands, electrically conductive elements and contacting means and/or coupling fibre strands, to span the entire heating textile.

Further embodiments are evident from the subclaims.

In a further advantageous form of embodiment it is conceivable that the heating textile comprises, apart from the functional fibre strands, additional supporting fibre strands which are configured as pillar fibre strands and/or as weft fibre strands. This is particularly advantageous when an excessively large free area would be present between mutually spaced electrically conductive elements such that the stability of the heating textile would be reduced. In this case, it has proved advantageous to introduce further supporting fibre strands as weft fibre strands. These stabilise the heating textile described herein and can be formed from the above-mentioned materials.

Furthermore, the supporting fibre strands serve for formation of the flexibility of the heating textile described herein with simultaneous maintenance of shape. Advantageously, the supporting fibre strands enable bending and draping of the heating textile depending on the respective case of use, for example for components of curved configuration. Similarly, it is also conceivable to construct support elements of that kind, as the supporting fibre strands can also be termed, instead of or additionally to the fibre strands from auxiliary threads which when further processing is carried out serve for enhanced connection with other materials.

In a further advantageous form of embodiment the heating textile is constructed as a non-crimp fabric, a woven fabric or a knitted fabric. Construction as a knitted fabric or also as a non-crimp fabric has proved particularly advantageous and simple in production. Particularly in the case of construction of the heating textile as a knitted fabric, wherein here the coupling fibre strands are formed as stitches which connect the further fibre strands together, it is possible for the first time to provide a heating textile which has a lattice structure. At the same time, the lattice structure is formed to be particularly firm and stable by virtue of the effect of the coupling fibre strands. Beyond that, the stitches of the coupling fibre strands create an at least partial encirclement of the fibre strands connected therewith so that a relatively compact binding with few interstices between the individual coupling fibre strands and the further fibre strands connected therewith is ensured. This makes possible for the first time—even after the possible process of coating the heating textile with, for example, a plastics material—further securing of the open lattice structure as well as reduction in coating material between coupling fibre strands and further fibre strands connected therewith. Break-off locations and excessive plastics material coating areas between the individual fibre strands are thus avoided. This gives rise to a significant increase in the quality of the heating textile, which is described herein for the first time.

In a further advantageous form of embodiment at least one insulating element is arranged between contacting means and electrically conductive fibre strands, wherein the contacting means are directly and/or indirectly connected by way of the coupling fibre strands with the at least one insulating element or the contacting means are directly and/or indirectly connected by way of the coupling fibre strands via the at least one insulating element with the electrically conductive fibre strands arranged below the insulating element.

The insulating element advantageously serves for decoupling between the contacting means and the electrically conductive elements so as to avoid a short-circuit at the points of intersection thereof. It is therefore additionally important to construct the coupling fibre strands from an electrically non-conductive material. In the simplest case, coupling fibre strands and insulating element can be constructed from the same material.

The at least one insulating element comprises at least one insulating material, preferably several insulating materials, which or are constructed to be electrically non-conductive. Materials for coupling fibre strands and/or insulating elements such as PES, other polymers such as, for example, polyethylene or polypropylene, natural fibres such as, for example, hemp, flax, kenaf and/or a mixture thereof have proved particularly advantageous.

In the case of these electrically insulating materials, processing of the insulating element in the heating textile can be carried out particularly simply. Through insertion and arrangement of the at least one insulating element exactly between the contacting means and electrically conductive fibre strands these are successfully decoupled from one another. For the purpose of simplified fixing, the contacting means are directly fixed with the coupling fibre strands at the at least one insulating element. Moreover, it is also conceivable for the contacting means to be stitched around through the at least one insulating element and for the electrically conductive fibre strands lying thereunder to be similarly stitched around. As a result, even better fixing and stability are created. The fixing advantageously takes place through warp knitting, weft knitting or laying. For that purpose, the insulating element is advantageously formed to be areal, for example as a non-woven material or also as a plastics material film.

In the simplest case, fixing of the contacting means with the at least one insulating element takes place by way of intermeshing in the process of warp knitting, weft knitting or laying during production.

The at least one insulating element can, in one embodiment, be formed to be continuous in longitudinal direction of the heating textile.

However, this is not to be understood as limiting, so that it is also conceivable for the at least one insulating element be to be arranged merely regionally on and/or at the crossing points of electrically conductive fibre strands and contacting means. It is always necessary to ensure that the insulating element fulfils its function and that undesired short-circuits or contacts between the contacting means and the electrically conductive fibre strands are avoided.

It has proved particularly advantageous that the two groups of contacting means, which advantageously form the positive pole and the negative pole of the heating textile described herein, are arranged closely adjacent to one another. By arranged closely adjacent to one another there is to be understood a mutual spacing in the centimetre range, for example a spacing of 0.2 to 10 centimetres. It is possible for the first time through this close arrangement to cut up the flexible heating textile individually in its area size without the heating function being destroyed. It is known from the prior art that positive and negative poles in known heating textiles are respectively arranged at the outwardly disposed edges to be spaced far from one another. This drastically restricts the finishing of heating textile and creates high production costs in order to produce individual heating textile sizes. This is solved for the first time with the heating textile described herein in that the positive pole and negative pole are for the first time arranged closely adjacent to and at the same time decoupled from one another. The lateral surfaces, which project therebeyond, of the heating textile can be freely finished. For example, it is conceivable for the positive pole and negative pole to be arranged in a lefthand edge region of the heating textile. The remaining area of the heating textile is formed merely by energy-delivering fibre strands and electrically conductive fibre strands, optionally also by supporting fibre strands. The remaining residual area can thus be freely finished, since all three mentioned kinds of fibre strand can be easily severed without the actual heating function being lost.

Moreover, it is also conceivable to arrange the positive pole and negative pole centrally in the middle so that the areas, which protrude laterally therebeyond, of the heating textile can be appropriately finished at the lefthand and righthand sides.

Alternatively, it would be conceivable to provide a respective group of contacting means at each of the two edge regions of the heating textile. Thus, a simple division between the groups can be realised and both heating textile parts would be fully functionally capable.

In a further, advantageous form of embodiment the heating textile comprises at least a first cut-out, which is formed to be free of fibre strands. This at least first cut-out is advantageously arranged between the positive pole and negative pole, insofar as no insulating element is provided. Advantageously, the cut-out can be regarded as an alternative to the above-described insulating element. The cut-out prevents formation of a short-circuit. With particular advantage the cut-out interrupts the electrically conductive fibre strands between the positive pole and the negative pole. This is necessary, since in the production method the electrically conductive fibre strands are introduced to be continuous in the heating textile. The fibre strands would therefore otherwise have contact with both the positive pole and the negative pole. A short-circuit would be created. In order to prevent this, the at least one first cut-out is provided. This can be applied particularly advantageously and quickly during the production method.

In the simplest case this takes place by punching out. Thus, all fibre strands used in the heating textile can be provided as pillar fibre strands and weft fibre strands, whereby production is accelerated and at the same time costs are reduced.

Moreover, it is conceivable for the heating textile to have an additional, second cut-out for contacting of the contacting means with the electrically conductive fibre strands. In this embodiment an insulating element is provided between the electrically conductive fibre strands and the contacting means. The insulating element itself has this second cut-out, so that the contacting means form direct contact with the electrically conductive fibre strands at this defined, predetermined position of the cut-out. A permanent connection is secured by the tight intermeshing of the electrically conductive fibre strands with the contacting means by way of the coupling fibre strands.

In a further advantageous form of embodiment the pillar fibre strands and weft fibre strands have an angle of 30° to 150° relative to one another. A corresponding lattice structure is thereby formed, since advantageously the pillar fibre strands and weft fibre strands also have a spacing from one another.

It has proved particularly advantageous to arrange the weft fibre strands at a spacing of 0.01 millimetres to 5 centimetres from one another. The pillar fibre strands can advantageously be selected with a fineness to a target between E1 and E50. The result is a lattice structure with open passage holes/passage openings which are formed by the spacing of the pillar fibre strands from the weft fibre strands or the pillar fibre strands from one another and the weft fibre strands from one another. This lattice structure is particularly advantageous when the heating textile is to be subsequently coated with a coating material, for example an aqueous synthetic material solution, since the synthetic material solution can appropriately drip down particularly due to the lattice structure and, in addition, the lattice structure remains after the coating is hardened. The lattice structure is advantageous for force dissipation and for flexible embedding in possible materials. The lattice structure ensures that the heating textile described herein can be embedded particularly satisfactorily and firmly in further materials.

In a further advantageous form of embodiment the energy-delivering fibre strands and/or the electrically conductive fibre strands and/or the supporting fibre strands and/or the contacting means are formed from electrically conductive non-insulated materials such as, for example, metals or compounds thereof, alloys and compounds thereof, organic materials such as materials containing carbon, electrically conductive polymers, metallised fibre strands or inorganic materials such as glass fibres and/or a mixture thereof. In the case of the energy-delivering fibre strands it has proved advantageous for these to have a high resistive impedance so as to produce an effective quantity of heat. In the case of the current-supplying—thus electrically conductive—fibre strands, materials such as, in particular, copper, stainless steel, copper alloys, gold, zinc or silver-coated copper have proved advantageous. In addition, materials containing carbon, PTC threads as conductive polymers and/or metallised textile threads are conceivable. The materials mentioned here can also be used as areal heating material advantageously in knitted form. It always has to be taken into consideration that the coupling fibre strands are formed to be electrically non-conductive.

Moreover, the heating textile described herein is characterised by the fact that it can be operated with a low protective voltage due to highly resistive threads and/or mains voltage. This is of significant advantage particularly for protection against overheating and also for power consumption.

In a further advantageous form of embodiment the heating textile is of two-dimensional and/or three-dimensional construction. This is of advantage, since a high degree of flexibility in the field of use of the heating textile is thereby realised.

The areal two-dimensional construction is of advantage if the heating textile is to be placed in thin components where a small material coating is specified. By virtue of the construction of the heating textile as a lattice element a high degree of stability and installation security can be guaranteed even in the case of thin material coatings.

Construction as a three-dimensional heating textile is particularly advantageous, since curved surfaces and structures are thereby reproduced and, for example, use in seat cushions or lying-down underlays (mattresses and the like) forms an additional field of use. By three-dimensional there is advantageously to be understood a multi-layered heating textile with at least one top surface and at least one base surface. The two surfaces are formed from pillar fibre strands and weft fibre strands which are the same and/or of different material, for example as a weft knitted fabric, a non-crimp fabric or a warp knitted fabric.

Moreover, the two surfaces are fixedly connected with one another and at the same time spaced from one another by way of spacer elements. Possible spacer elements can advantageously be pole threads, which are, for example, arranged at the respective points of intersection of pillar fibre strands and weft fibre strands at each surface. The pole threads connect the two surfaces together. Apart from that, loopings, interweavings, knittings, lays and the like are also conceivable.

It has proved particularly advantageous in the three-dimensional construction of the heating textile to integrate, in the case of a lattice element of that kind constructed as a heating textile, the heating textile described herein into the top surface and/or the base surface. Consequently, the heating textile described herein then directly forms the top surface and/or the base surface of the three-dimensional construction. This integration takes place during production and can thus be realised particularly simply and economically. Thus, the above-described heating textile can form the top surface and/or the base surface of the multi-layer heating textile. By virtue of the advantageous construction of the spacer elements, for example also as endless spacer threads, a plurality of spacer elements is formed. By virtue of their construction these can create, for example, a spring function and thus assign an additional flexibility and damping function to the three-dimensional heating textile.

Moreover, an appropriate material reinforcing or also simply a spacer between base surface and top surface is also conceivable. In order to include textile heating in the three-dimensional heating textile it is important to work the individual fibre strands, as described above, into the top surface and/or base surface. In that regard, apart from the warp knitting method, the layer method or the weft knitting method has proved particularly advantageous.

With particular advantage the three-dimensional heating textile in its unchanged initial form, thus without any external force loading, has a material thickness of, in total, 0.5 to 700 millimetres. A material thickness in the range of 1 to 50 millimetres has proved particularly advantageous. The material thickness, thus the spacing between the base surface and the top surface from one another, of 8 millimetres is especially advantageous. With these special material thicknesses there is given for the first time a sufficient flexibility of the heating textile with simultaneous maintenance of the stability of the warp knitting, lay or weft knitting connections. Moreover, it is advantageous to arrange the looping points, thus the connections of base surface and top surface, to be congruent with one another. As a result, particularly in the case of a crescent-shaped course of the spacer elements, a high level of restoring force is produced, which after loading with force enables return to the desired shape, thus the initial position without the loading.

Apart from the crescent-shaped course it is also conceivable to provide a zigzag shape or a sawtooth shape of the course of the spacer elements between the base surface and the top surface. Moreover, interruptions which are themselves of hexagonal form are also constructed. The combination of hexagonal arrangement and hexagonal construction of the interruptions offers the largest possible load-bearing capability and compression resistance, as well as shear stability over the entire area of the upper top surface.

With particular advantage, six hexagonal interruptions arranged hexagonally relative to one another are provided in an area region of 1 to 3 square centimetres, wherein the dimensions of the interruptions are formed in the range of 1 to 4 millimetres in width and 1 to 10 millimetres in length. Obviously this is not to be understood as limiting, so that it is also conceivable to provide, particularly in the case of green roofs, significantly larger dimensions of the interruptions, so that the interruptions in an area range of 25 to 50 square centimetres can have dimensions in the range of 5 to 50 millimetres in width and 10 to 80 millimetres in length.

The interruptions can obviously also have the same dimensions in the width thereof as in the length thereof. The dimensions already mentioned above are also applicable. The hexagonal construction is obviously not to be understood as limiting, so that it is also possible to form the interruptions to be polygonal as well as, for example, round, rectangular, oval, lozenge-shaped, square, triangular or in another polygonal shape.

In an alternative, advantageous embodiment of the heating textile the coupling fibre strands are in part replaced by the energy-delivering fibre strands, in which case the original energy-delivering fibre strands are now replaced by supporting fibre strands. The energy-delivering fibre strands at the same time form stitches so that the weft fibre strands are meshed or stitched around with the pillar fibre strands in such a way that pillar and weft fibre strands are tightly connected with one another at the crossing points thereof.

Through the stitch formation of the energy-delivering fibre strands there is formed between these and the electrically conductive fibre strands more contact points than in the case of a non-crimp fabric of weft fibre strands and pillar fibre strands.

As a result, the electrical contact resistance between the energy-delivering fibre strands and the electrically conductive fibre strands is significantly reduced, which leads overall to higher efficiency of the heating textile.

Moreover, in addition to the heating textile, as described above, the present invention relates to the method for producing this heating textile. The method comprises at least the following steps:

providing at least one pillar fibre strand feed for the feed of pillar fibre strands,

providing at least one weft fibre strand feed for the feed of a plurality of weft fibre strands arranged at a mutual spacing,

coupling pillar fibre strands and weft fibre strands together by simultaneous warp knitting or weft knitting or laying of at least one coupling fibre strand with formation of stitch-like connections.

The method described herein describes for the first time the production of a technical heating material in the form of a lattice element, wherein, as described above, weft fibre strands and pillar fibre strands are arranged relative to one another or weft fibre strands and pillar fibre strands are arranged at a spacing from one another and thus a lattice structure with continuous openings is formed. This technical heating textile lattice, as the above-described heating textile can also be termed, is constructed in such a way that the pillar fibre strands are warp knitted, weft knitted or laid with the weft fibre strands or conversely in that these are advantageously stitched around or meshed at their crossing points with one another by at least one coupling fibre strand.

In particular, the stable knitted connection is formed by the introduction of at least one coupling fibre strand, advantageously several coupling fibre strands, which are inserted or worked as a group. Advantageously, the coupling fibre group is guided per pillar fibre row by a respective apertured needle. The crossing points of pillar fibre strands and weft fibre strands are thereby stitched around in succession and thus fixed to one another. With particular advantage the stitching-around is controlled by a predeterminable thread tension so that it is also ensured that the weft fibre strands and pillar fibre strands are arranged against one another in order to initially stretch the heating textile in its area.

In a particular case, production of the heating textile is carried out in such a way that the weft fibre strands can be formed as supporting fibre strands and/or electrically conductive fibre strands. The pillar fibre strands can in that case be constructed as energy-delivering fibre strands as well as contacting means.

Moreover, it is conceivable for the method described herein to comprise a further method step which is performed between steps b) and c). This further method step, as described in a further advantageous form of embodiment, consists of feeding at least one insulating element between the pillar fibre strands. This is particularly advantageous, since the feed of the at least one insulating element during the production process is carried out, so to say, simultaneously with the knitting taking place downstream thereof. For that purpose, the at least one insulating element is advantageously of areal form and is correspondingly fed by way of, for example, a conveying device. Consequently, the at least one insulating element runs below the pillar fibre strands and above the weft fibre strands to the manufacturing process.

With the feed of the at least one insulating element, the stitching around is then carried out in a next step. The at least coupling fibre strand, which advantageously is formed as a coupling fibre group with several fibre strands, is picked up by a needle guided upwardly from below and correspondingly knitted. It can thus be ensured that the stitching-around of pillar fibre strands and weft fibre strands is permanently and securely realised by the at least one insulating element disposed therebetween.

With particular advantage the apertured needle is guided upwardly from below through the work plane so as to engage the at least one coupling fibre strand. In this example, the pillar fibre strand feed is similarly arranged above and the weft fibre strand feed below the at least one insulating element which is fed.

In an alternative, advantageous method the coupling fibre strands are replaced in part by the energy-delivering fibre strands, wherein the original energy-delivering fibre strands are replaced by supporting fibre strands. In that case, the pillar fibre strands and the weft fibre strands are intermeshed or stitched around at the crossing points with one another so that pillar and weft fibre strands are tightly connected together at their crossing points. The energy-delivering fibre strands are each fed by way of a respective apertured needle so that the stitching around of the pillar and weft fibre strands takes place in controlled manner with a predeterminable thread tension.

Further, the present method is distinguished by the fact that the warp knitted or laid or weft knitted heating textile in the optional step of the production method is taken off flatly and/or steeply. The take-off of the heating textile, which subsequently can undergo still further treatment steps, for example coating, is crucial to stitch strength. Thus, for example, a steeper fabric take-off directly after the production process, particularly when this has the form of a knitting process, gives rise to a significantly stronger stitch formation than is the case with a comparatively flat fabric take-off.

Apart from that, further processing steps such as, for example, coating or finishing off can also follow.

Moreover, the present invention also relates to a system for producing a flexible heating textile as described above and/or a system for carrying out the production method similarly as described above. For that purpose, the system comprises at least the following components:

a) a pillar fibre strand feed for feeding pillar fibre strands above or on a second side of the work plane,

b) weft fibre strand presenting means for arranging the weft fibre strands, at least one slide element and at least one casting-off element, wherein the weft fibre strand presenting means, slide element and casting-off element are arranged below or on a first side of a work plane,

c) at least one needle for warp knitting or laying or weft knitting of at least one coupling fibre strand, advantageously coupling fibre groups, in the form of stitches around the fibre strands to be connected together.

The system described here for the first time has been developed specifically for the production of technical textiles, particularly the functional technical heating textile described herein. It is now possible to produce technical textiles quickly and with high quality and saving of time by way of the process of weft knitting or warp knitting or laying. Processing of technical fibre strands such as described herein, for example glass fibre strands, electrically conductive fibre strands and the like, could not previously be produced directly on known textile systems. Amongst other things, these could not maintain the necessary fibre tensions since conventional fibres such as, for example, cotton have completely different characteristics, such as, for example, a PTC thread.

In a further advantageous form of embodiment the system comprises at least one feed device for feeding at least one insulating element between weft fibre strands and pillar fibre strands, wherein at least one projection for holding down the insulating element during the production process is arranged at at least one free end of the pillar fibre strand feed.

This system is a specific embodiment of the system with use of the above-described insulating element. By virtue of the construction, which is hereby described for the first time, of the system for production of the heating textile it is possible for the first time to create reliable and rapid product manufacture in a compact process within the work plane. In particular, in that regard it is of advantage if at least one projection, advantageously in the form of a nose, for holding down the at least one insulating element is provided at at least one end of the pillar fibre strand feed. This projection also keeps the at least one insulating element substantially flat during the production process, thus while the coupling fibre strands, weft fibre strands and pillar fibre strands are meshed through the at least one insulating element.

With advantage, a common contact area between weft fibre strands and insulating element is thereby formed. Through holding down the at least one insulating element in the work plane and thus also during the manufacturing process, particularly during the knitting process, it can be ensured that the pillar fibre strands arranged thereabove and the weft fibre strands arranged therebelow can be intermeshed with one another particularly securely and without a large expenditure of force. Undesired waving of the insulating element is thus precluded.

In a further, advantageous embodiment of the system, the system under point c) similarly comprises at least one needle for warp knitting or laying or weft knitting of at least one energy-delivering fibre strand, advantageously energy-delivering fibre groups, in the form of stitches around the fibre strands to be connected.

This is possible for the first time with the machine described herein or with the system described herein. Thus, in summary, a particularly effective system can be provided which significantly reduces the processing time for production of a corresponding heating textile and enables finishing in a way capable of being individualised. It is possible for the first time with the system described herein to produce and realise any size relationships in area, as well as also three-dimensionally one above the other, in compact mode of manufacture, particularly the mode of knitting.

Finally, the present invention also relates to use of the heating textile described herein in motor vehicle interior spaces for the heating of interior strips, vehicle seats, in greenhouses for direct temperature control of plant pots, outdoors for temperature control of plants growing over that, as seat cushions, lying-down underlays or lying-down mats for example in the form of mattress components, sports mat components, yoga mat components or relaxation mat components. Moreover, the present invention also relates to the use of the above-described heating textile in the building field for the heating of building parts such as roofs and/or walls and/or as a textile reinforcing element. In this case, the flexible heating textile can have the function of a heating mat, serve for de-icing or, however, also be utilised for temperature control of moulds or components. With particular advantage, a three-dimensional lattice element with an integrated heating textile can additionally be provided as a reinforcing element in concrete components. This is of significant advantage in, for example, the de-icing of bridges.

By bendable there is primarily to be understood that the heating textile can deflect from its original flat, horizontal plane without the functionality or quality being reduced. In particular, in that regard deflections of more than 5° from the horizontal are to be understood.

Advantages and functionalities are to be inferred from the following description in conjunction with the drawing, wherein:

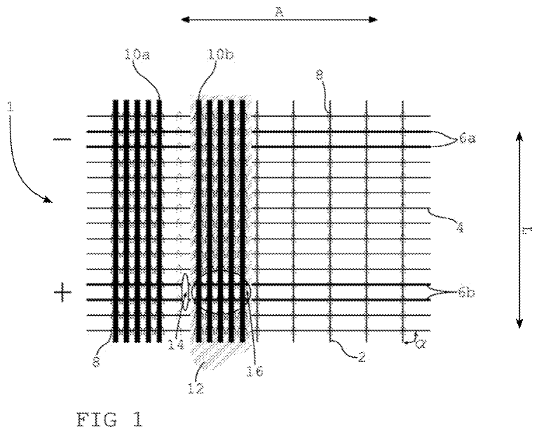

FIG. 1 shows a schematic plan view of a first form of embodiment of the heating textile according to the invention,

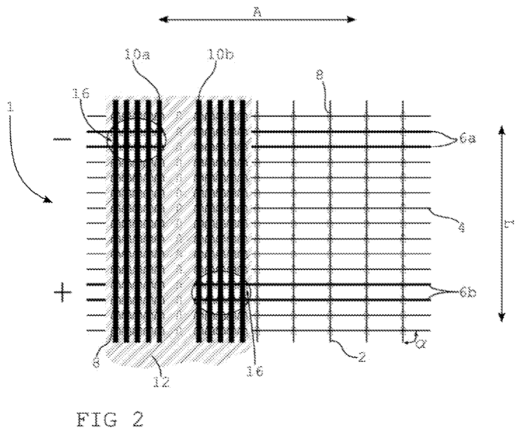

FIG. 2 shows a schematic plan view of a further form of embodiment of the heating textile according to the invention,

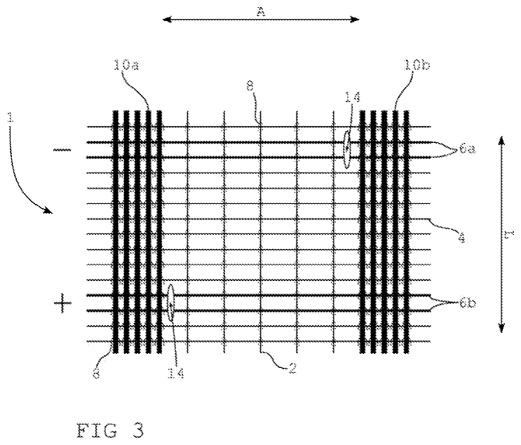

FIG. 3 shows a schematic plan view of a further form of embodiment of the heating textile according to the invention,

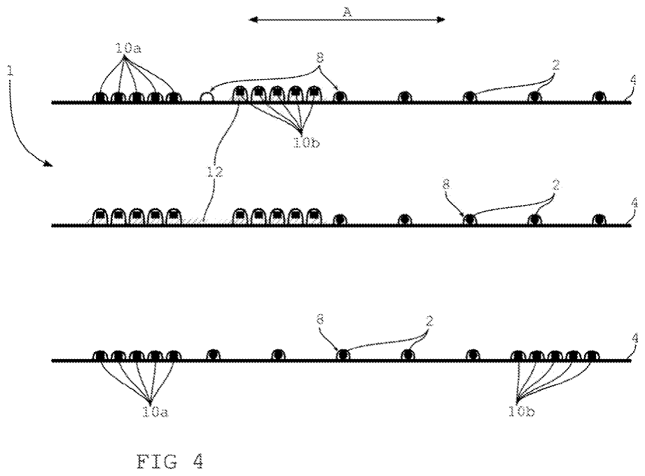

FIG. 4 shows schematic sectional views of the heating textiles of FIG. 1 to FIG. 3,

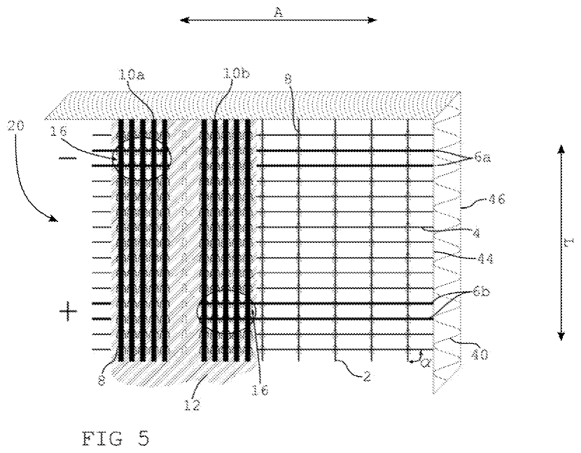

FIG. 5 shows a schematic view of a three-dimensional lattice element with an integrated heating textile according to the invention,

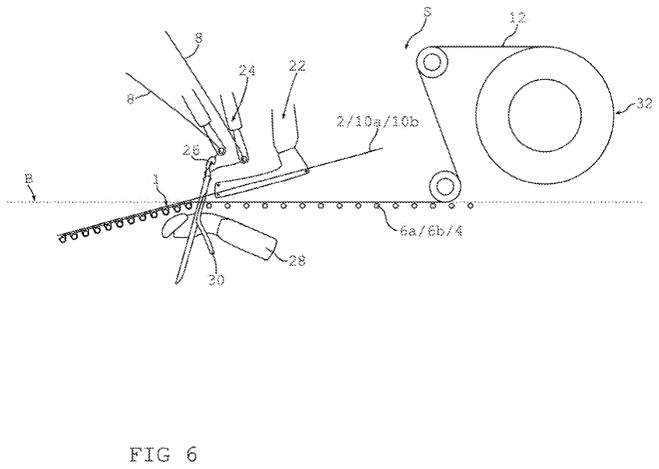

FIG. 6 shows a schematic sectional view of a system for producing the heating textile,

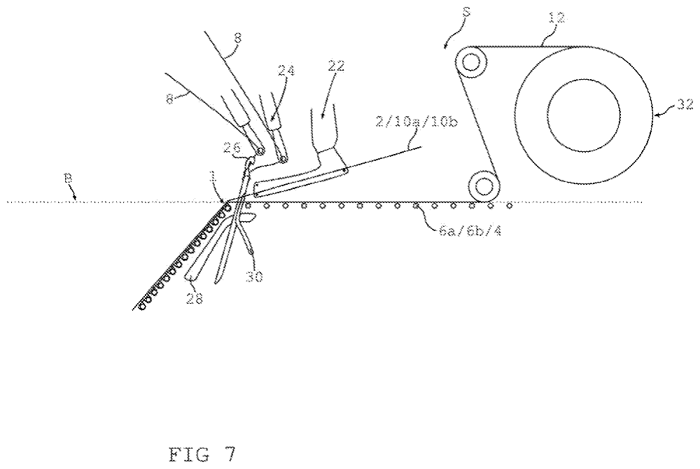

FIG. 7 shows a further schematic sectional view of a system for producing the heating textile,

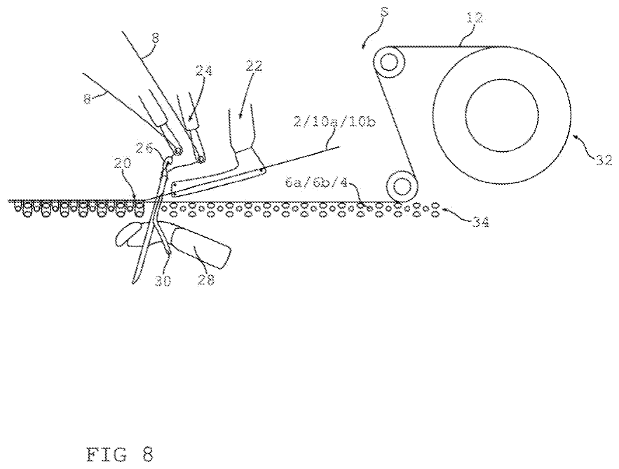

FIG. 8 shows a further illustration of a system for producing a three-dimensional heating textile,

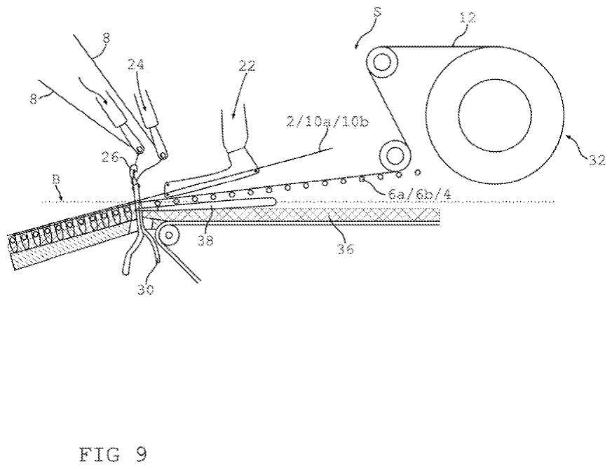

FIG. 9 shows a further sectional view of a further heating textile and

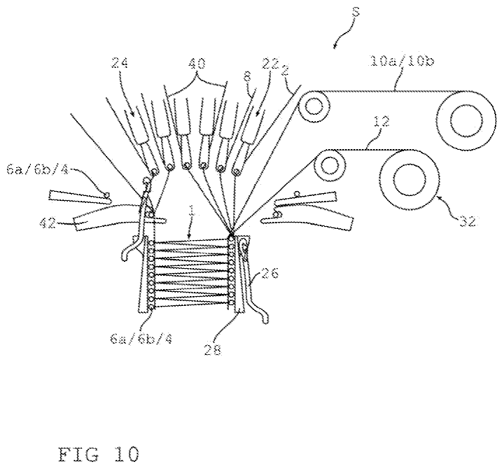

FIG. 10 shows a sectional view of a system for constructing a further three-dimensional lattice element with an integrated heating textile.

A schematic plan view of a first form of embodiment of a heating textile 1 is shown in FIG. 1, wherein L corresponds with the longitudinal direction, thus the transport direction, and A with the working width. In addition thereto it is pointed out that all views shown in FIGS. 1 to 3 reproduce merely the smallest repetition unit in longitudinal direction. Advantageously, a plurality of these units is provided in the longitudinal direction L of the heating textile 1. The pillar fibre strands are introduced in the longitudinal direction L, while the weft fibre strands are introduced in the direction of the working width A.

The heating textile 1 is formed from 0° fibre strands, which extend in length direction L, and 90° fibre strands, which extend in working width direction A.

In the simplest case the weft fibre strands extend, as shown here, at an angle α to the pillar fibre strands. They can serve for support of the heating textile 1 and/or for the feed of electrical energy by way of corresponding electrically conductive fibre strands 6a, 6b. The electrically conductive fibre strands 6a in this example here form the negative pole. This is formed from one or more electrically conductive fibre strands 6a or fibre strand groups. These are configured to be spaced from one another. The electrically conductive fibre strands 6b form the positive pole. These can similarly be formed from one or more fibre strands or fibre strand groups, which are similarly spaced from one another.

Moreover, two groups of contacting means 10a, 10b are provided.

Coupling fibre strands 8 are provided for the fixing of pillar fibre strands and weft fibre strands to one another. These can, as shown here, advantageously be selected and formed as enmeshing in stitch form from the group of fringe, tricot, cloth, satin, velvet, atlas and open body. However, this is not to be understood as limiting, so that fixing can also be by way of winding around, looping around or the like.

In addition, at least one insulating element 12 is arranged. This is arranged between the electrically conductive fibre strands 6a, 6b and the contacting means 10b and decouples these from one another. The contacting means 10a, 10b are advantageously formed as contacting fibre strands. The contacting means 10b are similarly connected by way of the coupling fibre strands 8 with the insulating element 12, for example stitched around or also knitted. In addition, the electrically conductive fibre strands 6a, 6b arranged below the insulating element 12 can also be gripped by the stitching around so that the insulating element 12 is arranged fixedly and incapable of slipping between the fibre strands 10a, 10b and 6a, 6b to be decoupled from one another. Creation of a short-circuit is thus successfully prevented.

In order to avoid a short-circuit between the positive pole and negative pole a first cut-out 14 free of fibre strands is arranged at the level of the electrically conductive fibre strands 6b. At the same time, this cut-out 14 is present between the two groups of contacting fibre strands 10a, 10b. In the simplest case, the cut-out 14 is formed as a punched-out portion. In addition, the form of embodiment of the heating textile 1 has yet a further cut-out 16. This is arranged below the contacting fibre strand group 10b, in the insulating element 12 at the level of the electrically conductive fibre strand 6b. This second cut-out 16 is similarly formed as a punched-out hole. It serves for contacting of the contacting means 10b with the electrically conductive fibre strands 6b. However, this takes place only within the size and dimension of the cut-out 16. The electrically conductive fibre strands 6a still remain insulated.

In the simplest case the contacting means 10a, 10b can also be formed as braids and/or bands, which group together several fibre strands. Connection with a power source is effected after exposure of a few centimetres sufficient for the purpose of application of a commercially available plug. Amongst other things, contact by splicing, soldering or glueing with a current-conducting cable is also possible.

Moreover, the heating textile 1 comprises energy-delivering fibre strands 2 which are introduced as pillar fibre strands spaced from one another.

FIG. 2 shows a further embodiment of the heating textile 1. The same reference numerals as before also correspond with the same components and are not explained again here.

By contrast to FIG. 1, the heating textile 1 in FIG. 2 exhibits an enlarged insulating element 12 which extends flatly and continuously below the two groups of contacting means 10a, 10b. In this embodiment there is formed, additionally to the cut-out 16 of FIG. 1, a further cut-out 16. This is formed at the level of the electrically conductive fibre strands 6a below the contacting means 10a in the insulating element 12. This arrangement of the two cut-outs 16 also prevents an undesired short-circuit.

The contacting means 10a, 10b are arranged closely adjacent to one another not only in FIG. 1, but also in FIG. 2. This has the advantage that the contacting means 10a, 10b are fixed in their position. The heating textile of pillar fibre strands and weft fibre strands, which in plan view extends onward as desired to the immediate right of the contacting means 10b, is to be produced and finished in its working width A entirely individually. Consequently, the adjacent arrangement of the contacting means 10a, 10b offers a significantly higher degree of flexibility of the heating textile geometry than is at all possible in the prior art.

A third embodiment of a heating textile 1 is shown in FIG. 3. Here, as well, the same reference numerals correspond with the same components as before and are not explained again.

This heating textile 1 also comprises pillar fibre strands and weft fibre strands. The contacting means 10a, 10b in this embodiment, being arranged opposite one another, are spaced far apart, advantageously at and/or in the respective edge regions of the heating textile 1. This embodiment is free of insulating element. In order to avoid a short-circuit this heating textile 1 has two cut-outs 14 free of fibre strands. The two cut-outs 14 in each instance respectively interrupt the electrically conductive fibre strands 6a, 6b.

Shown in FIG. 4 are side views of FIG. 1 (top), FIG. 2 (centre) and FIG. 3 (bottom). It is apparent here that the insulating elements 12 are positioned differently up to the point of complete omission. In addition, the contacting means 10a, 10b are arranged at a different mutual spacing. Moreover, here the warp knitted and/or weft knitted and/or laid stitches, of the at least one coupling fibre strand 8 are illustrated. It is evident that these stitches engage around and thus fix not only pillar fibre strands, but also weft fibre strands at the points of intersection thereof. If an insulating element 12 is provided, it is similarly apparent that the stitches run through the insulating element 12 so that the insulating element 12 is worked between the pillar fibre strands 2 and weft fibre strands 4.

In the case of, in particular, stitching-around of the crossing points of merely pillar fibre strands 2 and weft fibre strands 4, thus without insulating element 12, the tight stitch guidance around the respective crossing point is apparent. By virtue of this tightly adjoining arrangement of the stitches of the at least one coupling fibre strand 8 there is almost avoidance of any free space between fibre strand and stitch. This has provided particularly effective when the thus-produced technical textile lattice element is subsequently coated with plastics material as corrosion protection. The coating can take place particularly effectively through the tight stitch formation. Excessive collection of coating material in the free spaces is avoided, whereby the workability and long-term life of the technical heating textile are significantly increased. Undesired coating material stresses and fractures are similarly avoided.

A three-dimensional textile 20, which integrates—as top surface 44 and/or as base surface 46 with spacer fibre strands 40—at least one heating textile 1 described herein, is shown in FIG. 5. The same reference numerals as before also correspond with the same components and are not explained again. A three-dimensional technical textile 20 with a heating function is, as a result, constructed for the first time. This can be used, for example, for road construction for de-icing of bridges, heating elements with textile reinforcement, seat cushions, lying-down underlays or mats, for example mattresses/sports mats, yoga mats or relaxation mats, for direct temperature control of plants and plant pots or also in the ground or also as a reinforcing element in overground construction or underground construction. The spacer fibre strands 40 are to be understood as spacer elements and can be constructed, for example, as pole threads as described above.

A schematic side view of a system S, which is needed for production of the heating textile 1, is now shown in FIG. 6. The system S comprises, in particular, a weft fibre strand feed (not shown) which introduces the weft fibre strands. In that case, electrically conductive fibre strands 6a, 6b or also supporting fibre strands 4 can be understood as weft fibre strands.

At least one pillar fibre strand feed 22 is arranged above the weft fibre strands. This feeds the pillar fibre strands to the work plane B. In this embodiment the contacting means 10a, 10b as well as the energy-delivering fibre strands 2 are fed by way of the pillar fibre feed to the work plane.

Further, several apertured needles 24, which provide the coupling fibre strands 8, are arranged above the work plane B.

Needles 26, casting-off elements 28 as well as slide elements 30 are arranged below the work plane B where the stitching around or the warp knitting or laying or weft knitting takes place. The needle 26 is initially guided upwardly from below through the work plane B so that the needle 26 can engage the coupling fibre strands 8, which are fed, above the work plane B. Subsequently thereto the needle 26 is guided further downwardly through the work plane B where this then is bound off by way of the slide element 28.

Optionally, in this embodiment the at least one insulating element 12 is, in addition, led in. The feed takes place exactly below the pillar fibre strand layer and above the weft fibre strand layer. The insulating element 12 is consequently arranged between weft fibre strands and pillar fibre strands. In the simplest case the at least one insulating element 12 is fed by way of a conveying device 32 to the working process. The conveying device can for that purpose comprise, for example, several deflecting rollers, the conveying tension of which is settable. It is thus ensured that the insulating element is fed at a speed matching the working process. Stresses or waving of the insulating element 12 is or are thus precluded.

The produced heating textile is taken off at the end of the working process or also manufacturing process. This can now take place flatly as shown in FIG. 6, for example at an angle of 5 to 30° with respect to the horizontal work plane B in the case of this embodiment.

The same construction as in FIG. 6 is again shown in FIG. 7. The same reference numerals here again correspond with the same components. However, the take-off of the heating textile 1 differs in FIG. 7. This is formed to be substantially steeper, for example in a range of 35 to 75° referred to the horizontal work plane B. As a result, particularly when a knitting process is used, the formed stitches of the coupling fibre strands are drawn particularly firmly around the fibre strands to be connected.

Moreover, a schematic side view of the system S is shown in FIG. 8. Here, too, the same reference numerals relate to the same components as previously explained. The difference from FIG. 1 is that here a three-dimensional textile 20 is produced. Thus, several layers 34 are introduced at the weft fibre strands, which are then, as explained above, appropriately stitched around and are warp knitted or weft knitted or laid with the coupling fibre strands 8. The depth, thus the thickness, of the three-dimensional textile 20 can be selected as desired.

A further schematic view of a system S is shown in FIG. 9, by means of which a further form of embodiment of the heating textile 1 described herein can be produced. In addition to the already explained components, in this embodiment fibre cuttings 36 are fed below the weft fibre strands. These are positioned by means of a fibre cuttings holding element 38. In the simplest case the fibre cuttings holding element 38 can be constructed as a holding-down device and the fibre cuttings 36 fed in controlled manner, for example flatly, to the work plane B. Coming into consideration as fibre cuttings are not only natural, but also synthetic fibre cuttings such as, for example, fibre-reinforced synthetic materials which are used for, for example, vehicle construction, in the wind power field, in aircraft and ship construction or the like.

Finally, FIG. 10 shows a further schematic view of the system S by which a further alternative form of embodiment of the heating textile 1 can be realised. Here the work plane B is tipped through 90° so that the actual warp knitting process or weft knitting process or laying process takes place in vertical direction. This differs from the above examples where processing takes place in horizontal orientation.

In the case of the cross-section illustrated here, a double-barred knitting machine with a 90° weft intake produces the heating textile 1 with the following characteristics. The pillar fibre strand feed 22 can here be constructed as a guide bar and with a pillar fibre strand feed (similarly to FIGS. 6 to 9). The energy-delivering fibre strands 2 and/or the coupling fibre strands 8 are introduced by it. The thread feed for stitch formation, which connects the textile together, in particular the contacting means 10a, 10b, are firmly contacted with the electrically conductive fibre strands 6a, 6b and/or the supporting fibre strands 4.

For formation of stitches, the coupling fibre strands 8 are processed by the apertured needle 24. It is to be emphasised that up to 75 square millimetres of contacting means 10a, 10b on 15 millimetres width are worked by multiple intake simultaneously with an individual intake of energy-delivering fibre strands 2.

The insulating element 12 with variably introduced cut-outs 14 or 16, which in the simplest case are punched out and are used for contacting, is fed by way of the conveying device 32. The feed takes place by way of individual product-dependent strips which can be arranged on a shaft with reels.

The electrically conductive fibre strands 6a, 6b are fed, optionally in alternation, to the supporting fibre strands 4, at 90° to the apertured needle 24. In a case of knitting machines and/or lay machines the weft intake can differ +/−60° from 90°.

The energy-delivering fibre strands 2 are fed by the pillar fibre strand feed 22. At the places with the contacting means 10a, 10b there is achieved in the thread feeders a multiple intake by a higher square (E3-E44). These are arranged directly in front of the needle bar. In the pillar fibre strand feed 22 the contacting means 10a, 10b can be drawn in parallelly with the energy-delivering fibre strands 2 in a bar by a guide bar similarly to the depiction in FIGS. 6 to 9. The energy-delivering fibre strands 2 can also be fed to the working process additionally or simultaneously via the guide rail 24.

The spacer fibre strands 40 are intermeshed with the textile surfaces in the knitting process. The pillar fibre strands each form a textile surface into which the spacer fibre strands are stitched.

Although the invention is more closely illustrated and described in detail by the advantageous embodiments described herein the invention is not restricted to the disclosed examples and other variations can be derived therefrom by the expert without departing from the scope of protection of the invention. In particular, the present invention is not restricted to the following feature combinations, but other combinations and part combinations plainly feasible to the expert can also be formed from the disclosed features.

### REFERENCE NUMERAL LIST

1 heating textile

2 energy-delivering fibre strands

4 supporting fibre strands

6a, 6b electrically conductive fibre strands

8 coupling fibre strands

10a, 10b contacting means

12 insulating element

14, 16 cut-out

20 three-dimensional textile

22 pillar fibre strand feed

24 apertured needles

26 needle

28 casting-off element

30 slide element

32 conveying device

34 layers

36 fibre cuttings

38 fibre cuttings holding element

40 spacer fibre strands

42 weft thread presenting means

44 top surface

48 base surface

B work plane

S system

L longitudinal direction

A working width

1. A heating textile for transmission of heat to an environment, comprising at least:
a. electrically conductive fibre threads configured for conducting electrical energy,
b. energy-delivering fibre strands configured for heating the environment,
c. contacts configured for forming at least one closed circuit, and
d. at least one coupling fibre strand configured for contacting coupling of the energy-delivering fibre strands with the electrically conductive fibre strands and/or of the contacts with the electrically conductive fibre strands,
wherein the electrically conductive fibre strands and/or the contacting fibre strands and/or the energy-delivering fibre strands are formed as pillar fibre strands and/or weft fibre strands, and
the at least one coupling fibre strand is warp knitted and/or laid and/or weft knitted directly or indirectly around the pillar fibre strands and weft fibre strands in stitch-like manner in order to connect these together.

2. The heating textile according to claim 1, further comprising supporting fibre strands for stabilisation thereof.

3. The heating textile according to claim 1, wherein the heating textile is formed as a non-crimp fabric, a weft knitted fabric or a warp knitted fabric.

4. The heating textile according to claim 1, wherein at least one insulating element is arranged between the contacts and the electrically conductive fibre threads, wherein the contacting fibre threads are connected by the coupling fibre thread with the at least one insulating element.

5. The heating textile according to claim 1, wherein the heating textile has at least one first cut-out which is formed to be free of fibre strands.

6. The heating textile according to claim 1, wherein pillar fibre strands and weft fibre strands have an angle of 30° to 150° relative to one another.

7. The heating textile according to claim 1, wherein the energy delivering fibre strands and/or the electrically conductive fibre strands and/or the supporting fibre strands and/or the contacts are formed from electrically conductive non-insulated materials such as metals and compounds thereof, alloys and compounds thereof, organic materials such as materials containing carbon, electrically conductive polymers, metalised fibre strands, inorganic materials such as glass fibres and/or a mixture thereof.

8. The heating textile according to claim 1, wherein the textile this is of two-dimensional or three-dimensional construction.

9. A method of producing a heating textile according to claim 1, comprising at least the steps:
a. providing at least one pillar fibre strand feed for the feed of pillar fibre strands,
b. providing at least one weft fibre strand feed for the feed of a plurality of weft fibre strands arranged at a mutual spacing,
c. coupling pillar fibre strands and weft fibre strands together by simultaneous warp knitting or weft knitting or laying of at least one coupling fibre strand with formation of stitch-like connections.

10. The method according to claim 9, comprising a further step of introducing at least one insulating element between the pillar fibre strands and the weft fibre strands between step b) and step c).

11. The method according to claim 9, wherein the knitted heating textile is taken off flatly and/or steeply.

12. A system for performing the method of claim 9, comprising at least:
a. a pillar fibre strand feed configured for feeding pillar fibre strands above or on a second side of the work plane, and at least one weft fibre strand presenter configured for arranging the weft fibre strands,
b. at least one slide element and at least one casting-off element, wherein the weft fibre strand presenter, slide element and casting-off element are arranged below or on a first side of a work plane,
c. a needle configured for warp knitting or laying or weft knitting of at least one coupling fibre strand, advantageously coupling fibre groups, in the form of stitches around the fibre strands to be connected together.

13. The system according to claim 12, further comprising at least one conveying device configured for feeding at least one insulating element between weft fibre strands and pillar fibre strands, wherein at least one projection configured for holding down the insulating element during the knitting process is arranged at at least one free end of the pillar fibre strand feed.

14. A treating textile as claimed in claim 1 in motor vehicle interior spaces for the heating of interior strips and vehicles seats, in greenhouses for direct temperature control of plant pots, in the outdoors for temperature control of growing over that, as seat cushions, lying-down underlays or lying-down mats in the form of, for example, mattress components, sports mat components, yoga mat components or relaxation mat components, in the building field for heating of parts of buildings such as roof and/or walls and/or as textile reinforcement elements.

15. The heating textile according to claim 2, wherein at least one insulating element is arranged between the contacts and the electrically conductive fibre threads, wherein the contacting fibre threads are connected by the coupling fibre thread with the at least one insulating element.

16. The heating textile according to claim 3, wherein at least one insulating element is arranged between the contact and the electrically conductive fibre threads, wherein the contacting fibre threads are connected by the coupling fibre thread with the at least one insulating element.

17. The heating textile according to claim 2, wherein the energy delivering fibre strands and/or the electrically conductive fibre strands and/or the supporting fibre strands and/or the contacts are formed from electrically conductive non-insulated materials such as metals and compounds thereof, alloys and compounds thereof, organic materials such as materials containing carbon, electrically conductive polymers, metalised fibre strands, inorganic materials such as glass fibres and/or a mixture thereof.
